(19) United States
(12) Patent Application Publication
(10) Pub. No.: US 2009/0214610 A1
(43) Pub. Date: Aug. 27, 2009

(54) BENZOIC ACID CONTAINING COMPOSITION FOR MAINTAINING HYDANTOINYLATED POLYMERS IN A BIOCIDALLY ACTIVE STATE

(75) Inventors: Michael A. Bridges, Seattle, WA (US); Hiroyuki Kawai, Kirkland, WA (US); Christine M. Palczewski, Seattle, WA (US); James R. Scott, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: HALOSOURCE, INC., Bothell, WA (US)

(21) Appl. No.: 11/909,968

(22) PCT Filed: Mar. 30, 2006
(86) PCT No.: PCT/US2006/011860

§ 371 Date: Aug. 18, 2008

Related U.S. Application Data
(60) Provisional application No. 60/667,207, filed on Mar. 30, 2005.

(51) Int. Cl. A01N 25/34; A01N 43/66; A01P 15/00

(52) U.S. Cl. 424/408; 514/241

(57) ABSTRACT

A tablet includes benzoic acid and trichloroisocyanuric acid. The tablet provides free available chlorine in water to maintain an N-halamine-containing polymer biocidal, without rendering the water undrinkable from high chlorine content. The tablet may be used in a water purification device having a cartridge containing an N-halamine polymer to provide safe drinking water.

### CROSS-REFERENCE TO RELATED APPLICATION

This application claims the benefit of U.S. Provisional Application No. 60/667,207, filed on Mar. 30, 2005, incorporated herein expressly by reference.

### FIELD OF THE INVENTION

The invention is related to water purification systems, including systems employing polymers having pendant heterocyclic amine groups, such as polystyrene having pendant hydantoin and halogenated hydantoin groups, and to the compositions and methods for maintaining the polymers in a biocidally active state.

### BACKGROUND OF THE INVENTION

Heterocyclic N-halamine groups are known to have biocidal properties that can be utilized in water purification. Heterocyclic N-halamine groups that are attached to a polystyrene polymer are described in U.S. Pat. No. 5,490,983, to Worley et al. A crosslinked polystyrene polymer having similar pendant heterocyclic N-halamine groups is described in U.S. Pat. No. 6,548,054, to Worley et al. The crosslinked version of the polystyrene polymer is typically provided as “beads” or particles that do not have the problems associated with the powdered version of the polymer described in the '983 patent.

The beads are available from Vanson HaloSource of Redmond, Wash. A representative heterocyclic amine group described in both of these patents is a hydantoin group. When the hydantoin group has a chlorine or bromine atom bonded to one or both of the hydantoin nitrogen atoms, the hydantoin is biocidal. The '054 patent describes the creation of the biocidal halogenated polystyrene hydantoin (HPSH, an N-halohydantoinylated polymer) polymer from the nonbiocidal polystyrene hydantoin (PSH) polymer using a variety of free available chlorine sources (for example, sodium hypochlorite, calcium hypochlorite, sodium dichloroisocyanurate). Over time however, the biocidal HPSH polymer reverts to nonbiocidal PSH polymer as a result of depletion of the halogen atoms due to contact with biodemand in the medium being treated. PSH polymer, however, has the ability to be recharged or rehalogenated with a halogen to restore its antimicrobial properties.

The '054 patent describes recharging PSH polymer once the polymer has lost its biocidal efficacy by halogenating the PSH polymer using concentrated solutions of industrial strength liquid bleach. It has been determined that the levels of halogen in solution according to the '054 patent are of such a high concentration that when used in situ in a water treatment device, the subsequent purified water is rendered undrinkable and requires considerable post-treatment to remove the excess halogen to render the purified water drinkable.

One of the drawbacks of using HPSH polymer in water filters is that once the halogen is consumed from the HPSH polymer, the halogen must be either replaced by recharging the halogen-depleted PSH polymer, or the entire mass of PSH polymer must be discarded and replaced with fresh HPSH polymer. Until now, there was no practical alternative to either recharging or replacing the PSH polymer in a water treatment system. Replacing halogen-depleted PSH polymer with fresh HPSH polymer raises the capital and operating costs of the water treatment system. Recharging PSH polymer that has lost biocidal efficacy requires that the water treatment system be taken out of service. Off-line recharging of PSH polymer to HPSH polymer creates considerable down-time and system complexity.

Another short-coming of HPSH polymers is the drop in biocidal efficacy during use. As halogen is consumed from the HPSH polymer, the biocidal efficacy of the HPSH polymer drops below commonly required biocidal performance standards, such as the United States Environmental Protection Agency's (EPA) standards of 6 log removal of Klebsiella, and 4 log removal of poliovirus. While the drop in biocidal efficiency is expected as halogen is consumed by the biodemand, the speed with which this reduced effectiveness occurs creates several difficulties for the practical application of the HPSH polymer, such as in a water filter in the home or as an emergency water supply. Product designers and engineers wishing to apply HPSH polymer technology to commercial products must either increase the initial amount of HPSH polymer to achieve the desired performance life of the product or add complexity to the system by allowing for off-line rehalogenation of the PSH polymer.

U.S. Patent Application Publication No. 2005/0104034, to Bridges et al., incorporated herein expressly by reference, describes a tablet capable of delivering free available chlorine and/or free available bromine in water at a low concentration range. When water with low concentrations of chlorine or bromine is semi-continuously or continuously brought into contact with a biocidal N-halohydantoinylated polymer, the polymer is capable of sustaining the normal biocidal activity. However, the low concentration of halogen does not render the water undrinkable. The Bridges application also describes a method for replenishing halogens on the N-halohydantoinylated polymer while maintaining the N-halohydantoinylated polymer biocidally effective. While the Bridges application does provide a useful tablet and method, newer tablets are needed that elute a uniform concentration over a prolonged period of time that also have extended shelf life and are generally temperature stable. The present invention provides these advantages and has additional benefits.

### SUMMARY OF THE INVENTION

One embodiment of the present invention is a tablet containing benzoic acid and trichloroisocyanuric acid that is capable of achieving concentrations of free available chlorine that replenishes chlorine on N-halohydantoinylated polymers simultaneously while the N-halohydantoinylated polymers continue being biocidally effective against microorganisms in the water, and without rendering the water unsuitable for drinking due to high levels of chlorine. Accordingly, the tablet of the present invention obviates the need to recharge or replace the N-halohydantoinylated polymers. Additionally, the tablet of the present invention is less prone to decay at elevated temperatures and provides a uniform release rate of free available chlorine (FAC) when compared to tablets not having benzoic acid and trichloroisocyanuric acid. The present invention further provides a method to maintain a biocidally effective halogen charge on N-halohydantoinylated polymers without adversely affecting water quality and does away with the need to recharge or replace the N-halohydantoinylated polymers due to the tablet's ability to maintain N-halohydantoinylated polymers from becoming halogen depleted.

One embodiment of the present invention treats the N-halohydantoinylated polymers with low concentrations of free available chlorine by supplying the water to be treated by the polymers with chlorine. The chlorine is supplied by the trichloroisocyanuric acid in the tablet. The water with chlorine then contacts the N-halohydantoinylated polymers thereby maintaining the polymers biocidal. The chlorine in the water alone may not be sufficient to kill microorganisms, however, the N-halohydantoinylated polymers will be effective against many microorganisms. Free available chlorine refers to the chlorine in water that is available to bond with a nitrogen atom on a heterocyclic amine. In addition to maintaining N-halohydantoinylated polymers in a biocidally active state, the tablet is chemically stable at elevated temperatures, is compatible with the chlorine source; provides uniform time release profiles; meets chronic and acute toxicology limits to make long-term consumer consumption possible; and is cost-effective for commercial production. The useful life of the tablet is estimated, but not limited to, treating about 40 liters to about 1,000 liters of water.

The tablet includes trichloroisocyanuric acid (TCCA) and benzoic acid. While the present invention may be discussed in the context of a tablet, the use of the tem should not be construed to limit the invention. Any solid phase article may be rendered capable of providing similar benefits. In one embodiment, the tablet may include only TCCA and benzoic acid, or in another embodiment, the tablet may also include one or more compounds that may aid in manufacturing the tablet or add nutritional value to the water. Additional components, such as magnesium stearate that may be included for the purpose of facilitating manufacturing into tablets or other articles, are not considered to materially effect the release of free available chlorine from the tablet. The tablet, according to the invention, may release about 0.1 ppm (mg/L) to about 3 ppm (mg/L) chlorine in water at room temperature (approximately 20° C.) when tested in accordance with the testing procedure described below in association with FIG. 9. Unless stated otherwise, determinations of FAC are made using the apparatus of FIG. 9 and FAC is expressed as units of ppm (mg/L).

One embodiment is a tablet that includes the synergistic combination of benzoic acid and TCCA, and only those other compounds, such as magnesium stearate, that would not materially affect the basic characteristics of the tablet being temperature stable and capable of delivering substantially uniform levels of chlorine. In one embodiment, the tablet consists essentially of benzoic acid and trichloroisocyanuric acid. In another embodiment, the tablet consists essentially of about 4% to about 10% trichloroisocyanuric acid and about 90% to about 96% benzoic acid, by weight.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical representation of apparatus to test the FAC elution profiles of tablets.

FIG. 2 is a graphical representation of the shelf life characteristics of a tablet in accordance with one embodiment of the invention;

FIG. 3 is a graphical representation of a comparison of the shelf life characteristics of tablets in accordance with one embodiment of the invention;

FIG. 4 is a graphical representation of a comparison of the shelf life characteristics of tablets in accordance with one embodiment of the invention;

FIG. 5 is a graphical representation of a comparison of the FAC elution profile of tablets in accordance with one embodiment of the invention;

FIG. 6 is a graphical representation of a comparison of the FAC elution profile of tablets in accordance with one embodiment of the invention;

FIG. 7 is a graphical representation of a comparison of the FAC elution profile of tablets in accordance with one embodiment of the invention;

FIG. 8 is a graphical representation of a comparison of the FAC elution profiles of tablets in accordance with one embodiment of the invention; and

FIG. 9 is a graphical representation of a comparison of the FAC elution profiles of tablets in accordance with one embodiment of the present invention.

### DETAILED DESCRIPTION OF THE PREFERRED EMBODIMENT

Benzoic acid, also known as benzenecarboxylic acid (C₇H₆O₂) is widely used as an antimicrobial food additive and a flavor agent/adjuvant. Unexpectedly, benzoic acid when combined with TCCA has proven to be useful in methods for maintaining N-halohydantoinylated polymers in a biocidally effective state that eliminates the need to recharge the polymers. A benzoic acid and trichloroisocyanuric acid-containing tablet will also be useful when used with a water purification device as described in U.S. Patent Application Publication Nos. 2005/0098506 and 2005/0072729; both applications are incorporated herein expressly by reference.

In one embodiment, a tablet made in accordance with the invention, includes about 5% to about 5.5% by weight TCCA and about 94.5% to about 95% by weight benzoic acid. In one embodiment, the tablet is an about ½-inch diameter round tablet with sharp edges and has a total weight of about 450 mg to about 500 mg. Tablets having this shape were made using a lab carver press (Parr Pellet Press, Parr Instruments Co.) The hardness of the tablet is about 40 Newtons (measured using an Erweka type tester TBH30). Unless stated otherwise, the tablets described herein were made using the same lab carver press.

In another embodiment, a tablet made in accordance with the invention, includes about 9% to about 5.5% by weight TCCA and about 91% to about 94.5% by weight benzoic acid. The tablet is an about ½-inch diameter round flat face tablet with a beveled edge and has a total weight of about 600 mg to about 700 mg. Tablets having this shape were made using a commercially available pilot tabletting unit (Kilian single punch station Model #SP300). The hardness of the tablet is about 40 to 80 Newtons (Erweka TBH30).

In another embodiment, a tablet made in accordance with the invention, includes about 4% to about 10% by weight TCCA and about 90% to about 96% by weight benzoic acid.

A tablet made according to the invention provides free available chlorine at concentrations of about 0.1 ppm to about 4 ppm (mg/L) in flowing water at about room temperature (20° C.).

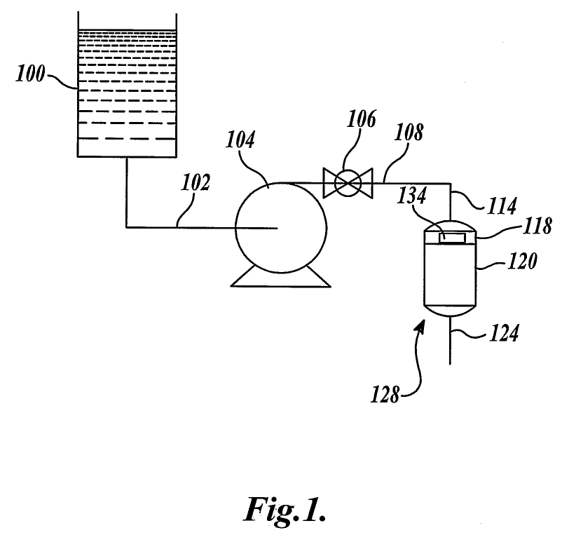

FIG. 1 illustrates a representative apparatus used in the measurement of free available chlorine in flowing water from articles, such as tablets. The experimental apparatus includes a water feed tank 100. The water feed tank 100 is connected to the suction side of the water feed pump 104. Line 102 connects the water feed tank 100 to the suction side of the water feed pump 104. The water feed pump 104 pumps water through a control valve 106. The control valve 106 meters the amount of water that is pumped by the water feed pump 104 to chamber 128. The water from the control valve 106 flows through the line 108. The water from line 108 flows into line 114. Line 114 delivers the metered amount of water to the chamber 128. The chamber 128 includes the compartment 118. Compartment 118 may contain an article 134, such as a tablet, made in accordance with the invention, or other tablets for comparison tests. The chamber 128 includes a second compartment 120, which is intended to hold biocidal beads. The second bead compartment 120 is empty for the tests. Free available chlorine of different articles can therefore be measured by reading the concentration of halogen in the water stream that exits the chamber 128. The testing environment is normally controlled at room temperature (about 20° C.) and the water temperature is also about 20° C. Total water flow can be determined by the level drop in tank 100 or by installing a metering device to integrate the total water flow.

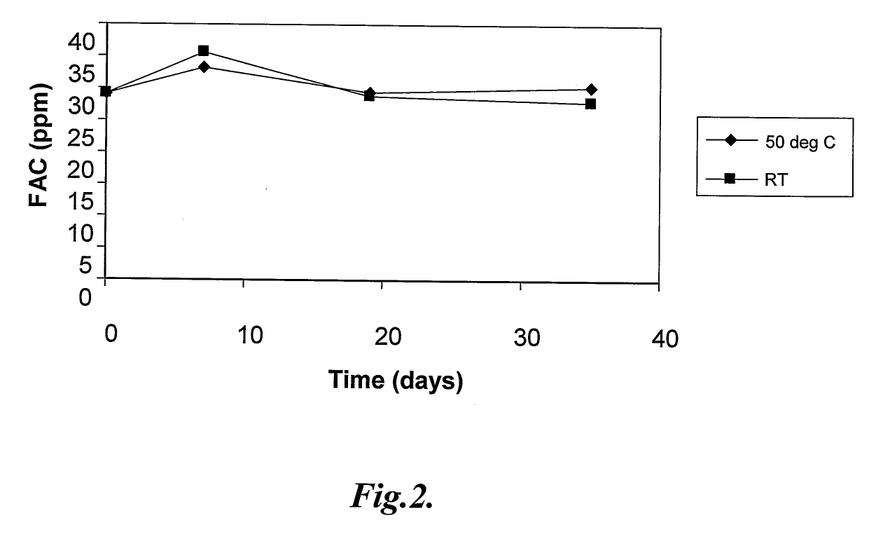

Quite unexpectedly, a tablet including benzoic acid and TCCA is stable at elevated temperatures. Temperature stability means that a tablet does not substantially lose the capacity to provide free available chlorine after being subjected for periods of time to a temperature higher than room temperature. Demonstration of this feature is shown in FIGS. 2-4.

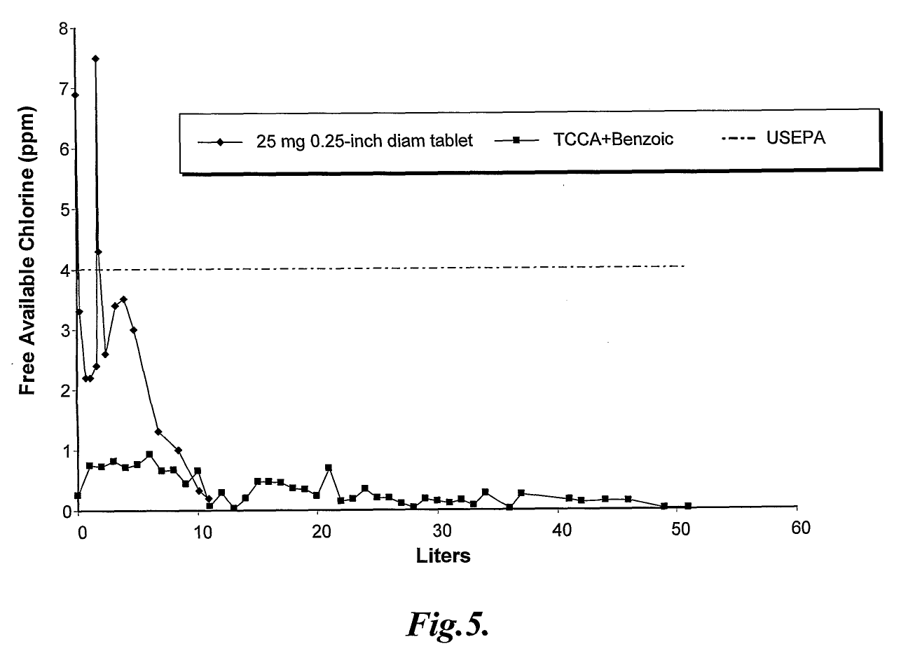

Quite unexpectedly, another advantage of a tablet having benzoic acid and TCCA is the ability of the tablet to provide a uniform concentration of FAC in the water. Uniform as used herein may include slight variations of the instantaneous readings of FAC over the elution profile of the tablet, however, the overall elution profile is generally within an upper and a lower boundary, so that any instantaneous reading of FAC does not deviate substantially from a median value. Demonstration of this feature is shown in FIGS. 5-7.

Benzoic acid has other advantages, for example, it was found that lubricants, such as magnesium stearate, commonly used in many formulations are not required when using benzoic acid and TCCA. No picking [?] or other common tabletting manufacturing problems were encountered using benzoic acid alone with TCCA. While not intending to be bound by theory, it is speculated that the lubricity provided by benzoic acid alone is similar to other lubricants.

### EXAMPLES

### Example 1

### Shelf-Life Test of Benzoic Acid and TCCA at Temperatures Up to 50° C.

Referring to FIG. 2, a tablet including 400 mg benzoic acid, 50 mg TCCA that was stored at about 50° C. provided approximately the same free available chlorine when compared with a tablet of the same composition, but stored at room temperature (about 20° C.) for the same length of time. The tablets were stored in plastic containers and subsequently sealed. Room temperature tablets were stored in a closet away from light. Elevated temperature tablets were stored in a darkened convection oven at about 50° C. Free available chlorine (FAC) was measured at various time intervals (in days). The test included placing a tablet, from storage, into a beaker filled with 4 liters of deionized water at room temperature. The beaker and tablet were set on a laboratory magnetic stirrer and the water was slowly mixed until the tablet dissolved. A sample of water from the beaker was taken and the FAC in the sample was measured using a HACH 4000U spectrophotometer (method 8021) for N,N-diethylphenylenediamine (DPD) reagent. The tablets maintained at room temperature (about 20° C.) and the tablets maintained at 50° C. provided a FAC of about 30 ppm in 4 liters throughout the test indicating substantially little to no degradation of TCCA at a temperature of about 50° C.

### Example 2

### Shelf-Life Test Comparison of Benzoic Acid with Various Chlorine Sources

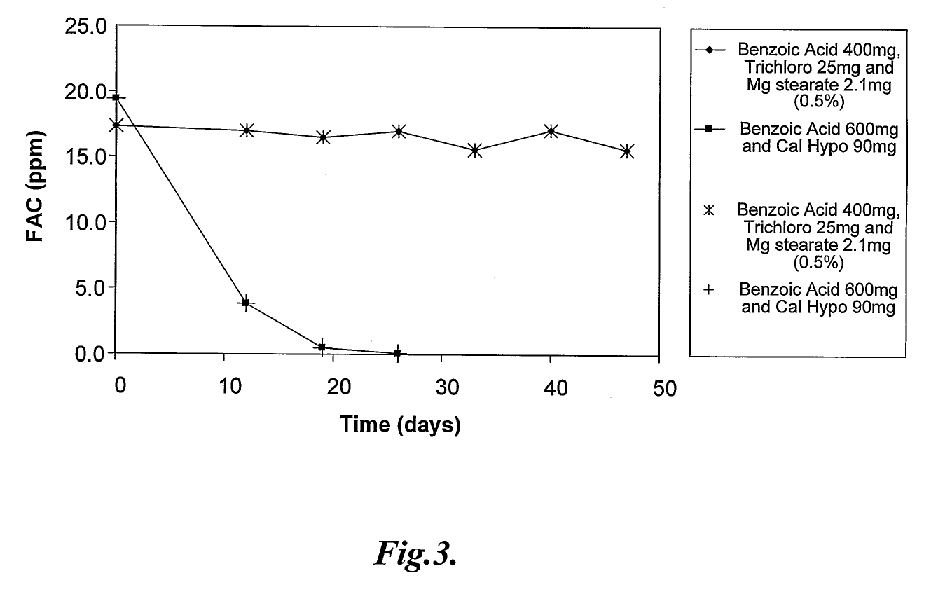

FIG. 3 shows a further embodiment of a tablet containing 400 mg. benzoic acid, 25 mg. TCCA, and 2.1 mg. (0.5%) magnesium stearate. The FAC delivered by the benzoic acid/TCCA/magnesium stearate tablet when subjected to a storage temperature of 50° C. remains substantially the same for periods extending to nearly 50 days. In contrast to tablets of benzoic acid, TCCA, and magnesium stearate, tablets containing calcium hypochlorite instead of TCCA, and benzoic acid of equal weight and equivalent chlorine availability showed a loss of the ability to provide FAC at elevated temperatures. FIG. 3 shows four trials. Two trials were made with tablets of benzoic acid, TCCA, and magnesium stearate and two trials were made with tablets of benzoic acid and calcium hypochlorite. The data for similar tablets correlated well to one another, so FIG. 3 shows overlapping data points. Tablets containing calcium hypochlorite and benzoic acid were made using the Carver Press (Parr Pellet Press, Parr Instruments Co.) with the same ½-inch diameter die and press, but containing 90 mg of calcium hypochlorite and 600 mg of benzoic acid and were stored at a temperature of about 50° C. Tablets were removed from storage at suitable time intervals (in days). Free available chlorine was measured by placing a tablet into a beaker filled with 4 liters of deionized water at room temperature. The beaker and tablet were set on a laboratory magnetic stirrer and the water was mixed until the tablet was completely dissolved. A sample of water was taken from the beaker and the FAC measured using a HACH 4000U spectrophotometer (method 8021) for N,N-diethylphenylenediamine (DPD) reagent. As shown in FIG. 2, the amount of FAC provided by a tablet made from benzoic acid and TCCA did not substantially diminish even when stored at 50° C. for nearly 50 days, while the tablet having benzoic acid and calcium hypochlorite loses substantially all ability to produce FAC after about 25 days when stored at 50° C.

### Example 3

### Shelf-Life Test Comparison of TCCA with Various Materials

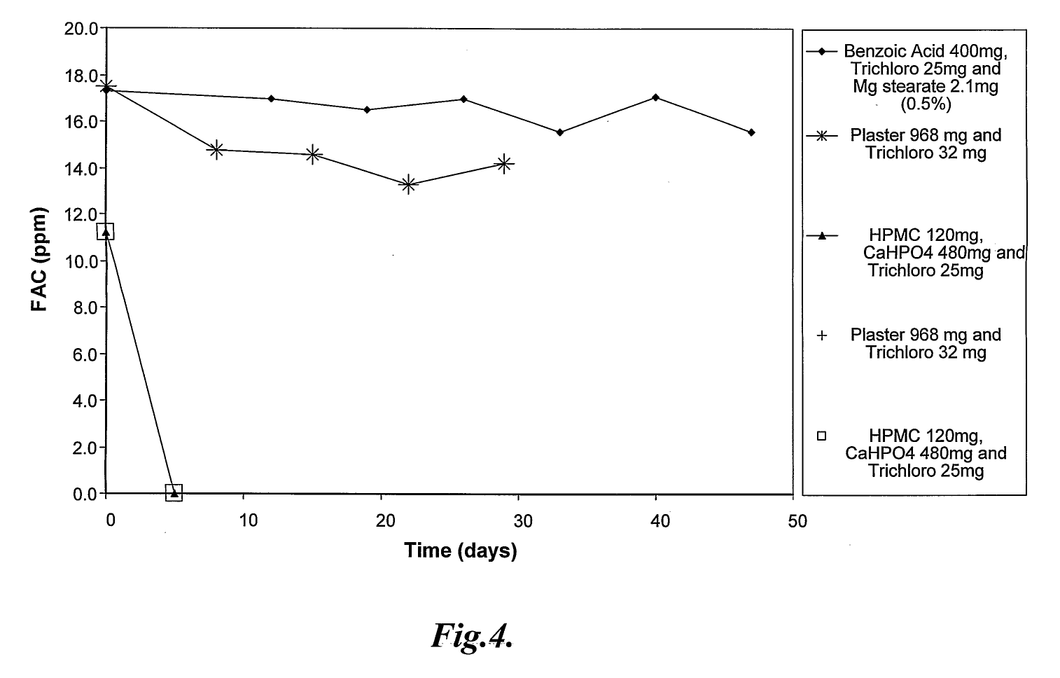

The FAC measurements of a tablet containing benzoic acid, TCCA, and magnesium stearate are again shown in FIG. 4 to compare against other formulations. A tablet containing 400 mg benzoic acid, 25 mg TCCA, and 2.1 mg magnesium stearate is shown to be temperature stable at about 50° C. for about 50 days, and perhaps longer. By comparison, a tablet of 120 mg hydroxypropylmethyl cellulose (HPMC), 25 mg TCCA, and 480 mg calcium hypophosphate lost all ability to generate free available chlorine within about 5 days. Surprisingly, a tablet made from 968 mg of plaster (gypsum) and 32 mg TCCA demonstrated only slightly reduced temperature stability as compared to the benzoic acid/TCCA/magnesium stearate tablet. However, the elution profile of the plaster/TCCA tablet was not similarly desirable to benzoic acid/TCCA tablets. It is also worthwhile to note that about 0.5% of magnesium stearate does not substantially effect the release rate of free available chlorine from tablets. FIG. 4 shows five trials. Two trials were made with tablets of plaster and TCCA and two trials were made with tablets of hydroxy propylmethyl cellulose and TCCA. The data for similar tablets correlated well to one another, so FIG. 4 shows overlapping data points.

### Example 4

### Demonstration of a Uniform Elution Profile of a Benzoic Acid and TCCA Tablet

FIG. 5 shows the time release profile of FAC of a tablet having 400 mg benzoic acid and 25 mg TCCA compared with the time release profile of FAC of a tablet having only 25 mg TCCA. The benzoic acid/TCCA tablet is a ½-inch diameter tablet made using the laboratory carver press (Parr Pellet Press, Parr Instruments Co.). The amount of TCCA is the same for both of the tablets. As shown in FIG. 5, the benzoic acid/TCCA tablet provided a substantially uniform concentration of FAC in water when compared with the tablet having only TCCA. As can be seen in FIG. 5, the tablet made with TCCA and benzoic acid was capable of providing free available chlorine for a longer period of time when compared with the tablet having only TCCA. The significance of this is that the elution of chlorine from 25 mg of TCCA can be extended by the introduction of benzoic acid. The benzoic acid/TCCA tablet was capable of extending the elution of free available chlorine from the 10 liter capacity of the TCCA-only tablet to about 50 liters by the introduction of benzoic acid. Additionally, unlike the TCCA-only tablet, the levels of FAC provided by the benzoic acid/TCCA tablet met the required levels of FAC in water to both maintain the biocidal activity of N-halohydantoinylated polymers, as well as also meet the recommended maximum contaminant level (MCL) for free chlorine (4 ppm) established by the United States Environmental Protection Agency (USEPA). Thus, a benzoic acid/TCCA tablet can be used to continuously maintain an N-halohydantoinylated polymer biocidally active, without causing the water to be rendered undrinkable because of high chlorine concentration in the water without the need for employing chlorine scavengers.

### Example 5

### Demonstration of a Uniform Elution Profile for a Benzoic Acid and TCCA Tablet

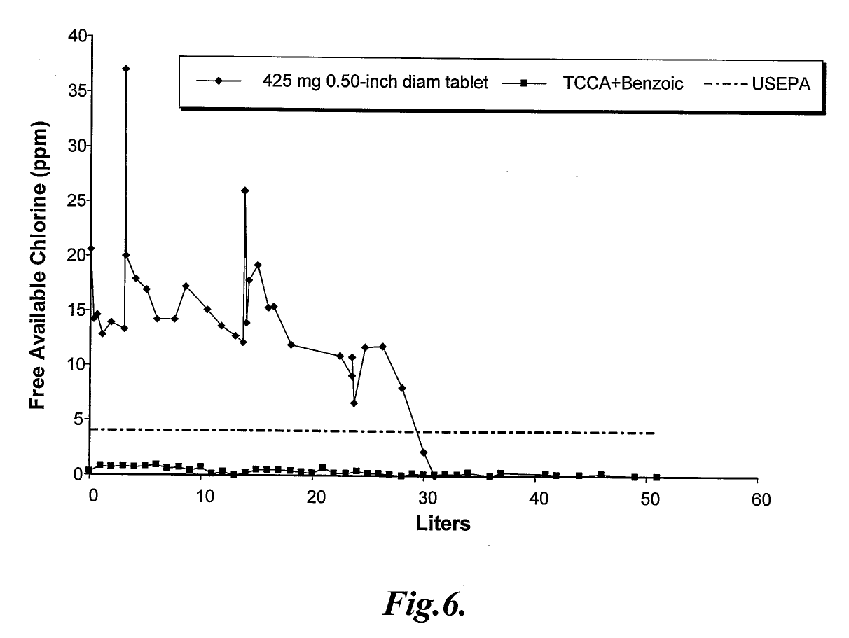

FIG. 6 compares the time release profile of the benzoic acid/TCCA tablet described in association with FIG. 5, to the time release profile of a 425 mg TCCA-only, ½-inch diameter tablet made using a laboratory carver press (Parr Pellet Press, Parr Instruments Co). The size and shape of the tablets were the same to determine whether surface area affects elution rates. As shown in FIG. 6, the benzoic acid/TCCA tablet provided a uniform elution profile of FAC compared to the TCCA-only tablet. Unlike the 425 mg TCCA-only tablet, the levels of FAC provided by the benzoic acid/TCCA tablet met the required levels of FAC in water sufficient to maintain the biocidal activity of N-halohydantoinylated polymers as well as also meet the recommended maximum contaminant level (MCL) for free chlorine (4 ppm) established by the United States Environmental Protection Agency (USEPA). Thus, the tablet of the present invention can be used to continuously maintain an N-halohydantoinylated polymer biocidally active, without causing the water to be rendered undrinkable due to a high chlorine concentration in the water without the need for employing chlorine scavengers.

As demonstrated above in Examples 4 and 5, the amount of TCCA and the size of the tablet are not the determinative factors in creating a tablet that provides an acceptable FAC elution profile. As demonstrated by the results shown in FIG. 5, the controlling factor in FAC elution is not the amount of TCCA. As demonstrated in FIG. 6, the surface area of the benzoic acid/TCCA tablet does not explain the advantageous FAC elution profile.

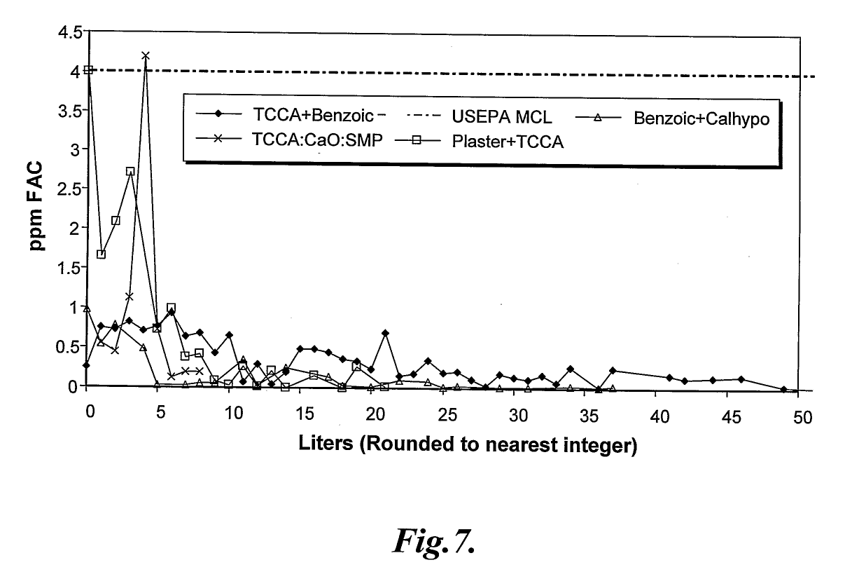

Free available chlorine elution tests were conducted on several other tablet formulations varying the amounts of, and even eliminating either the TCCA and/or the benzoic acid component. Surprisingly, no other halogen source combined with benzoic acid provided an adequate elution profile as compared to the elution profile of the benzoic acid/TCCA tablet. Surprisingly, no other excipient combined with TCCA provided an adequate elution profile as compared to the elution profile of the benzoic acid/TCCA tablet, as discussed above. FIG. 7 shows the elution profiles of FAC of tablets using various halogen sources besides TCCA, and various excipients besides benzoic acid. The elution profile of the benzoic acid/TCCA tablet from FIGS. 5 and 6 is provided for comparison. Table 1 lists the amounts and components of the tablet formulations.

TABLE 1
OTHER FORMULATIONS

| | | Nominal | Amount of the | |
|---|---|---|---|---|
| Tablet | Diameter | Hardness | halogen source | Amount of Excipient |
| (1) Benzole Acid + Calcium | ½ inch | 40 Newtons | 90 mg Calcium | 600 mg of benzoic acid |
| hypochlorite | | | hypochlorite | |
| (2) TCCA:CaO:Cyanuric acid | ½ inch | 40 Newtons | 30 mg TCCA | *570 mg of cyanuric acid |
| | | | | *30 mg of calcium oxide (CaO) |
| (3) Plaster (CaSO4) + TCCA | ½ inch | 40 Newtons | 40 mg TCCA | 600 mg CaSO4*½H2O |
| (4) TCCA:sodium | ½ inch | 40 Newtons | 28 mg TCCA | *540 mg cyanuric acid |
| metaphosphate:HPMC | | | | *60 mg Hydroxypropyl- |
| | | | | methyl cellulose |
| (5) Calcium benzoate:benzoic | ½ inch | 40 Newtons | 60 mg calcium | *300 mg benzoic acid |
| acid:calcium hypochlorite | | | hypochlorite | *300 mg calcium benzoate |

All of the tablets of Table 1 were made using a Carver Press (Parr Pellet Press, Parr Instruments Co.) with a ½-inch die and punch identical to the one used to make the benzoic acid/TCCA tablet. Tablet (1) is similar to the tablet used in the temperature stability study discussed above. Tablet (2) is made from organic and inorganic chemicals known to be compatible with TCCA and have been used in the manufacture of tablets for other purposes. Tablet (3) uses an inorganic cementitious agent, calcium sulfate, commonly used to make plaster of paris. It was believed that tablet (3) would prevent the quick elution of TCCA from the tablet. Tablet (4) uses excipients common in the manufacture of a variety of tablets used for pharmaceuticals. Tablet (5) has a salt of benzoic acid, calcium benzoate, to test the comparison between the protonated carboxylic group (in benzoic acid) and a benzoic acid salt (calcium benzoate). Other benzoic acid salts such as sodium benzoate and magnesium benzoate were not considered appropriate, as these salts are readily soluble in water and display different properties than calcium benzoate and benzoic acid. As shown in FIG. 7, none of the tablets in Table 1 demonstrated an elution profile as long as the elution profile of a tablet with benzoic acid and TCCA, nor does any other tablet have as uniform an elution profile as the elution profile of a tablet with benzoic acid and TCCA.

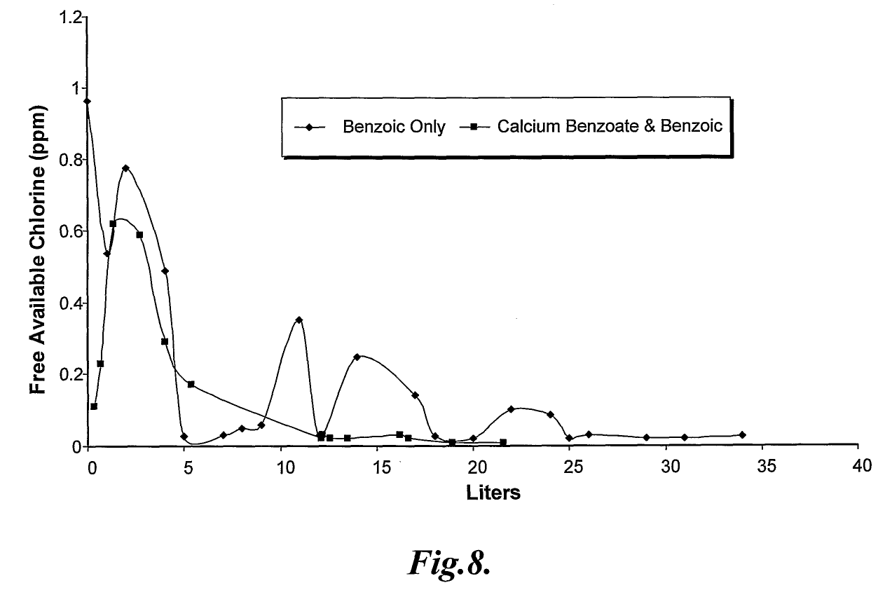

Of particular note is the comparison between tablet (1) and tablet (5). FIG. 8 shows the elution profiles of the two tablets. For both tablets, the elution profile did not last as long as the elution profile of the benzoic acid/TCCA tablet. Surprisingly, the benzoic acid with the protonated carboxylic acid group eluted FAC for nearly twice the volume as compared to calcium benzoate, which was surprising because both benzoic acid and calcium benzoate are sparingly soluble in water, and it would be expected that the calcium salt would have eluted the same, if not more FAC.

### Example 6

### Demonstration of Scaling the Elution Rate with a Benzoic Acid and TCCA Tablet

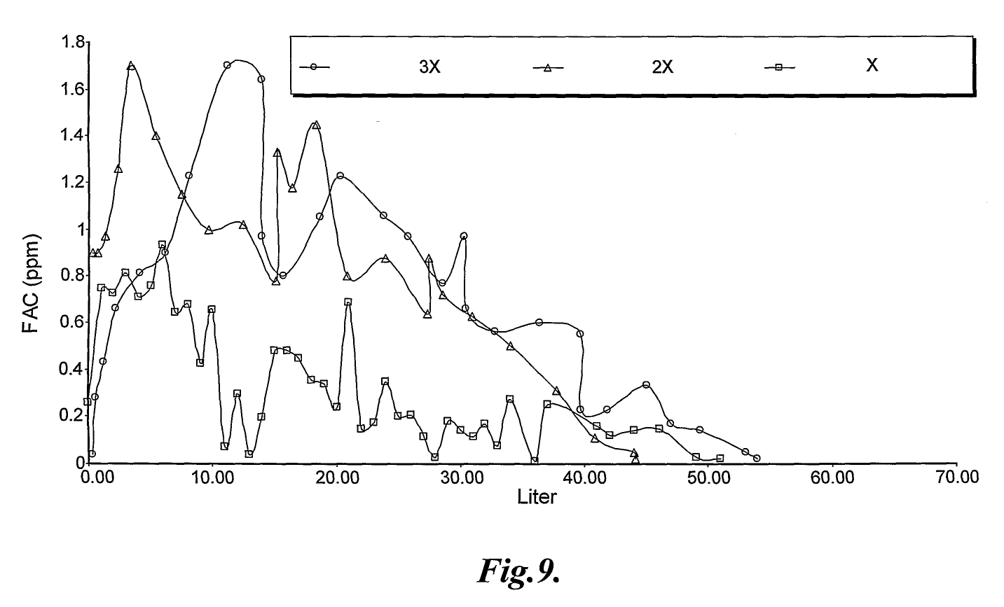

Another advantage discovered with a tablet containing benzoic acid and TCCA is that the peak elution rate can be scaled up or down. As shown in FIG. 9, doubling (2×) or tripling (3×) the weight of the tablet of benzoic acid and TCCA, while maintaining the same ½-inch diameter and ratio of 5% TCCA to 95% benzoic acid causes the peak elution rate to increase without affecting longevity of the elution profile. This allows adjusting the elution profile by increasing the overall weight of the tablet, but keeping the ratio of TCCA to benzoic acid the same.

While the preferred embodiment of the invention has been illustrated and described, it will be appreciated that various changes can be made therein without departing from the spirit and scope of the invention.

1. A tablet, comprising benzoic acid and trichloroisocyanuric acid.

2. The tablet of claim 1, further comprising magnesium stearate.

3. The tablet of claim 1, comprising about 5% to about 9% trichloroisocyanuric acid and about 95% to about 91% benzoic acid, by weight.

4. The tablet of claim 1, comprising about 5% to about 5.5% trichloroisocyanuric acid and about 94.5% to about 95% benzoic acid, by weight.

5. The tablet of claim 1, wherein the tablet is chemically stable at temperatures up to 50° C.

6. The tablet of claim 1, wherein the tablet further comprises a tableting aid.

7. The tablet of claim 1, wherein the hardness of the tablet is about 40 to about 80 Newtons.

8. The tablet of claim 1, further comprising about 0.5% magnesium stearate, by weight.

9. The tablet of claim 1, comprising about 4% to 10% trichloroisocyanuric acid and about 90% to 96% benzoic acid, by weight.

10. A method for maintaining an N-halamine-containing polymer biocidal, comprising, contacting an N-halamine-containing polymer with water having a concentration of free available chlorine of less than 4 ppm (mg/L), wherein the free available chlorine is supplied by a tablet comprising benzoic acid and trichloroisocyanuric acid.
